(19) United States
(12) Patent Application Publication
(10) Pub. No.: US 2019/0297781 A1
(43) Pub. Date: Oct. 3, 2019

(54) DRYING RACK FOR PLANT MATERIAL

(71) Applicant: Gary Palmer, Winchester Bay, OR (US)

(72) Inventor: Gary Palmer, Winchester Bay, OR (US)

(21) Appl. No.: 16/239,065

(22) Filed: Jan. 3, 2019

Related U.S. Application Data
(60) Provisional application No. 62/652,061, filed on Apr. 3, 2018.

(51) Int. Cl. A01F 25/12; F26B 25/18; F26B 9/10

(52) U.S. Cl. CPC A01F 25/12; A23B 7/02; F26B 9/10; F26B 25/185

(57) ABSTRACT

In one embodiment, a drying rack system includes a frame including horizontal members and vertical members, an array of brackets supported by the frame, and a plurality of clamping hangers supported by the brackets. A first clamping hanger of the plurality of clamping hangers may include a pair of opposing clamping jaws configured to compress against each other, and a hinge securing the clamping jaws together proximal one end of the first clamping jaw.

### CROSS REFERENCE TO RELATED APPLICATIONS

This application claims priority to U.S. Provisional Application, Ser. No. 62/652,061, filed on Apr. 3, 2018, which is hereby incorporated by reference for all purposes.

### BACKGROUND

The present disclosure relates generally to racks for drying and/or curing crops. In particular, modular rack systems configured to hold plant crops by their stems while air drying are described.

Dried and/or cured plant crops are an important commodity in a number of industries. Furthermore, plant crops are increasingly grown on a small scale by individuals seeking to realize the benefits of small batch products. Plant crops that require or benefit from a drying and/or curing step include various types of teas, tobacco, a wide range of herbs and spices, and decorative flowers, to name a few. Common methods of drying such plant material may utilize improvised clothes line type systems, wire hangers, or shelving not specifically designed for drying plant material.

These known devices for drying plant material are not entirely satisfactory for the range of applications in which they are employed. For example, existing devices and methods make it cumbersome, difficult and time consuming to secure the plant material to the drying rack. Furthermore, conventional methods may result in damage to the plant material from over handling or compression of the plant material. In addition, conventional drying devices may not make efficient use of the drying space.

Thus, there exists a need for devices for drying plant material that improve upon and advance the design of known devices. Examples of new and useful devices relevant to the needs existing in the field are discussed below.

### SUMMARY

The present disclosure is directed to drying rack systems for drying plant material. In one embodiment, a drying rack system includes a frame including horizontal members and vertical members, an array of brackets supported by the frame, and a plurality of clamping hangers supported by the brackets. A first clamping hanger of the plurality of clamping hangers may include a pair of opposing clamping jaws configured to compress against each other, and a hinge securing the clamping jaws together proximal one end of the first clamping jaw.

In one embodiment, the first clamping hanger may include a clasp configured to selectively hold the clamping jaws shut. In one embodiment, the first clamping hanger includes a series of grooves, the series of grooves configured to receive the clasp and selectively adjust the compression of the clamping jaws. In one embodiment, the first clamping hanger comprises a first compressible member disposed on a first clamping jaw of the pair of opposing clamping jaws.

The system of claim 4, wherein the first clamping hanger comprises a second compressible member disposed on a second clamping jaw of the pair of opposing clamping jaws, the first and second compressible members configured to compress against each other when the clamping jaws are shut. In one embodiment, the first compressible member comprises a rubber material.

In one embodiment, the frame comprises removable fasteners fastening the vertical members to the horizontal members. In one embodiment, the drying rack comprises a removable catch tray disposed proximal the bottom of the frame. In one embodiment, the vertical members include vertical slots, each bracket being secured to the vertical members via the vertical slots. In one embodiment, the first clamping hanger is supported on each end via a pair of opposing brackets of the array of brackets. In one embodiment, each of the pair of brackets comprises opposing notches, the notches being configured to receive the ends of the first clamping hanger and hold the clamping jaws shut.

### BRIEF DESCRIPTION OF THE DRAWINGS

FIG. 1 is a perspective view of a first example of a modular drying rack.

FIG. 2 is a front elevation view of the drying rack shown in FIG. 1.

FIG. 3 is a detail view of the modular drying rack depicting a notched bracket extending horizontally to support a number of removable clamping hangers.

FIG. 4 is top cross section view of the notched bracket showing the hand-adjustable fastener.

FIG. 5 is a front elevation view of a removable clamping hanger depicting the hinge and clamp mechanism.

FIG. 6 is a front prospective view of the removable clamping hanger, depicting the hanger with the jaws open to accept plant matter.

FIG. 7 is a front elevation view of the removable clamping hanger depicting plant matter arranged in the clamping jaws.

FIG. 8 is a perspective view of the modular drying rack of FIG. 1 depicting a full load of plant material being dried.

### DETAILED DESCRIPTION

The disclosed devices for drying plant material will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, a variety of examples of devices for drying plant material are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

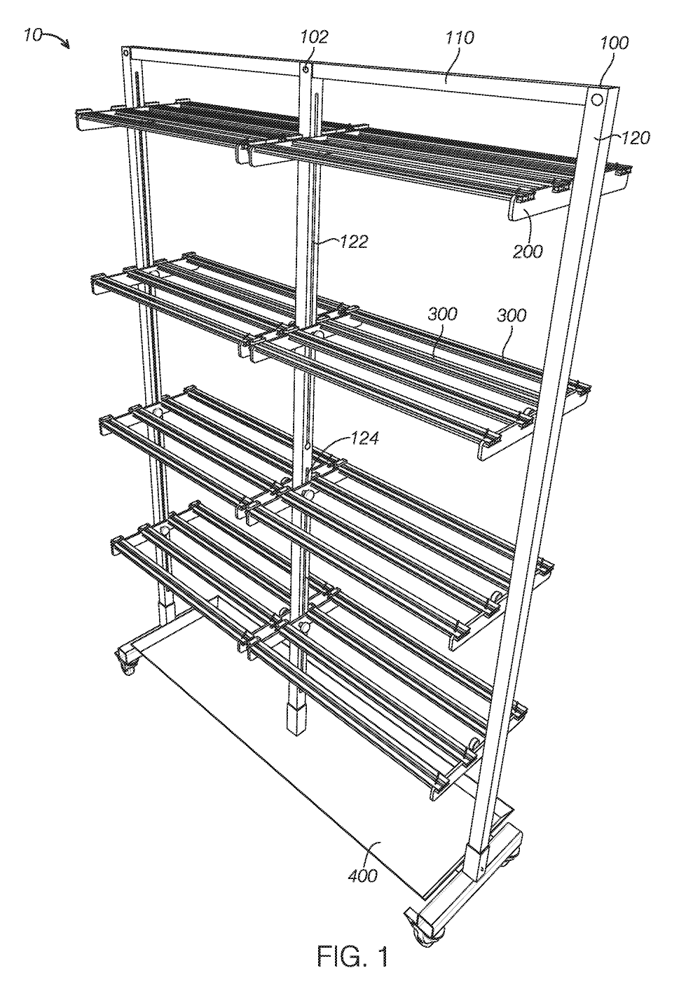

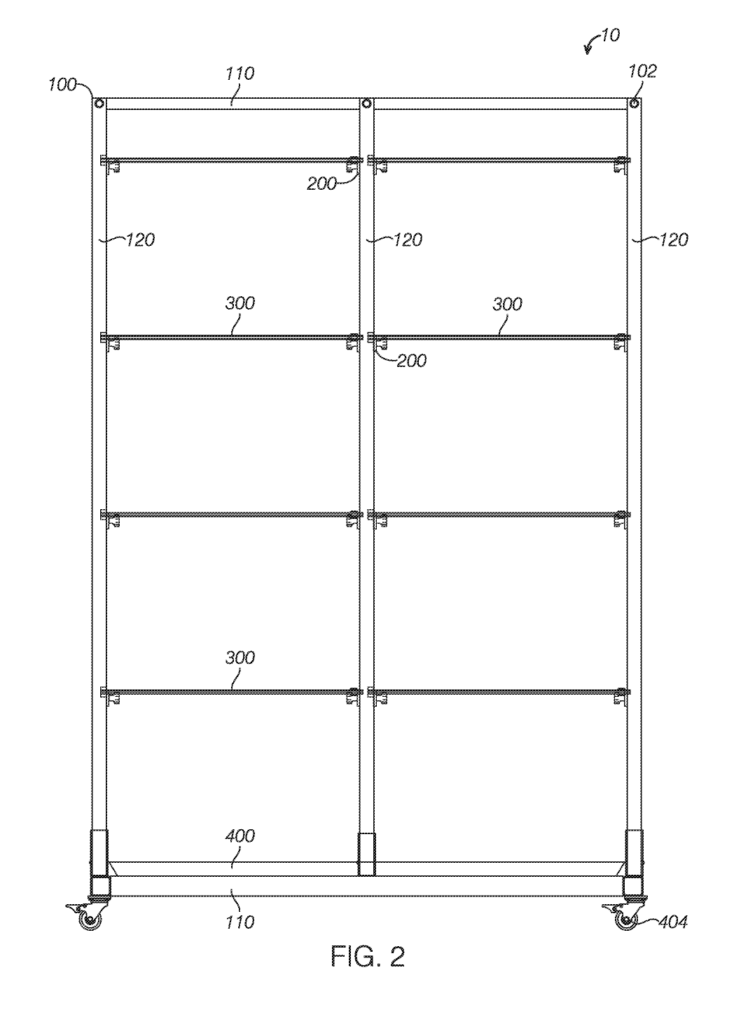

With reference to FIGS. 1-2 a first example of a device for drying plant material, device 10, will now be described. Device 10 functions to efficiently and evenly dry and/or cure plant material.

Device 10 addresses many of the shortcomings existing with conventional plant drying devices. For example, device 10 clamps softly and securely on the stem of the plant material and thus does not damage any leaves or flowers. Furthermore, device 10 makes very efficient use of the drying space by efficiently stacking the plant material in all three special dimensions. Additionally, it is exceeding quick and easy to secure device 10 to the plant material, reducing overall handling time. Finally, device 10 is modular, allowing multiple plant material drying devices to be used in conjunction with each other, placed side by side, front to back or stacked vertically to make the most efficient use of the drying space.

As shown in FIG. 1, device 10 includes a support frame 100 supporting an array of brackets 200, the brackets 200 supporting rows of removable clamping hangers 300. In some examples the support frame 100 may include wheels 404 and/or removable catch tray 400.

Support frame 100 is comprised of horizontal members 110 and vertical members 120. The horizontal and vertical members 110, 120 may be secured to each other via removable fasteners 102. Thus, the support frame may be easily disassembled for storage or transport. In other embodiments, the horizontal and vertical members 110, 120 may be welded to each other or otherwise permanently secured.

The vertical members 120 support rows of brackets 200, which in turn support the clamping hangers 300. Brackets 200 may be secured to vertical members 120 via removable fasteners 124. In the illustrated example, the vertical members 120 include vertical slots 122. The fasteners 124 may be threaded through a hole in the bracket 200 and through a vertical slot 122. The bracket 200 may be secured to the vertical member 120 via clamping action achieved by tightening the fastener. The bracket may be vertically repositioned by loosening the fastener 124 and sliding the bracket 200 vertically, then tightening the fastener 124 again. Thus, the vertical position of the bracket 200 may be adjusted, e.g., to accommodate plant material of different lengths. In other examples, the brackets may be non-adjustable or they may be permanently affixed to the vertical members.

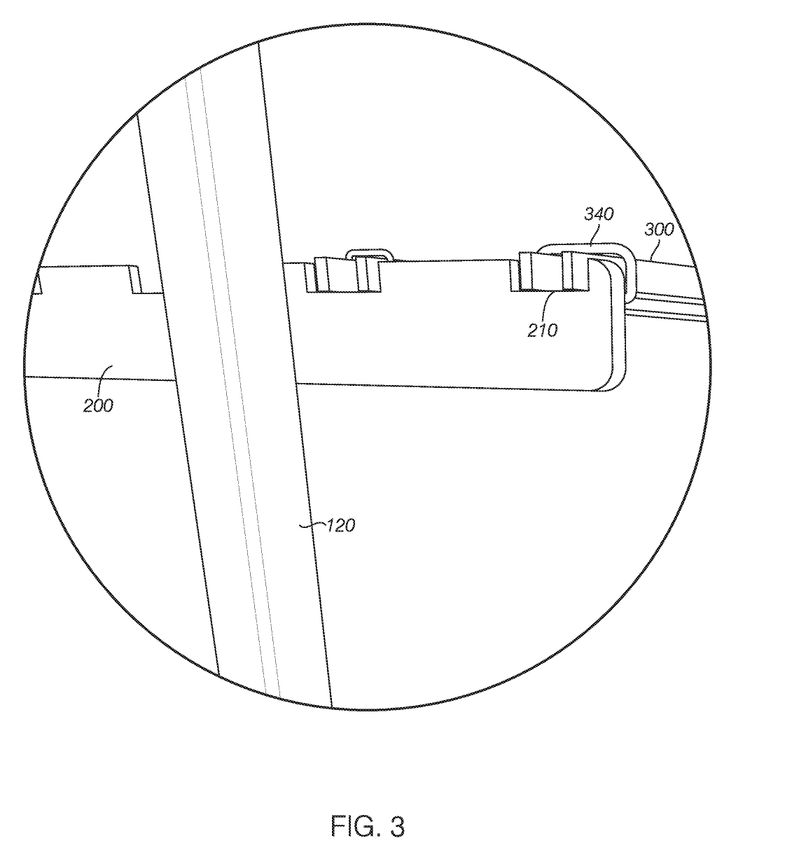

Turning now to FIG. 3, each bracket 200 may have a series of notches 210 disposed on the top edge of the bracket 200. As shown in FIG. 1, the notches 210 in one bracket 200 may correspond to the notches 210 in an opposing bracket 200 on an adjacent vertical member 120. A removable clamping hanger 300 may be secured in one of these pairs of opposing notches 210 by lowering the ends of the clamping hanger 300 into the notches. Thus, the clamping hanger 300 may be easily removed by simply lifting it up out of the slots 210.

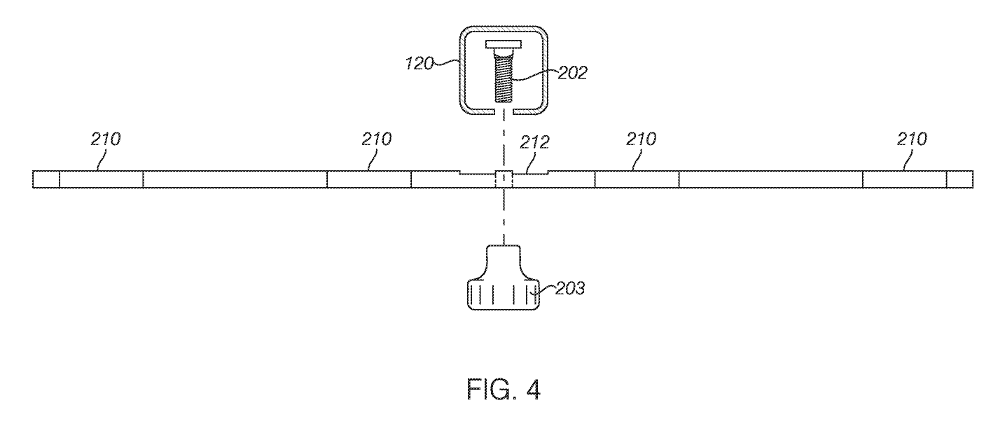

Turning now to FIG. 4, a top cross-section view of the bracket 200 and vertical member 120 is shown. As described above, brackets 200 may be secured to vertical members 120 via removable fasteners 124 threaded through vertical slots 122. In the illustrated embodiment of

FIG. 4, removable fasteners comprise a bolt 202 and a hand-adjustable nut 203. Bolt 202 may be slid inside vertical member 120 with the threads protruding. The threads may then be padded through a hole in bracket 200 and nut 203 may be threaded onto bolt 202, thereby securing the bracket to the vertical member 120. The bracket may include grooves 212 on one face of the bracket. Grooves 212 may be configured to mate with vertical member and the vertical slots 122 therein. Grooves 212 may serve to prevent the bracket from rotating relative to the vertical member 120.

Clamping hanger 300 may have a hinge 330 proximal one end and a clasp 340 proximal the opposing end. The pairs of opposing brackets 200 may be spaced apart, via vertical members 120, such that the hinge 300 and clasp 340 each sit just inside their respective bracket 200. The hinge 300 and clasp 340 may be larger than the notches 210. In this manner, the clamping hanger 300 is prevented by the hinge 300 and clasp 340 from sliding out of the opposing brackets 200 in either direction.

Turning now to FIG. 3, one example of removable clamping hanger 300 is shown. Clamping hanger 300 includes a pair of opposing clamping jaws 310, 320 rotatably secured to each other proximal their respective first ends via hinge 330. Clamping hanger 300 includes clasp 340 rotatably secured to clamping jaw 310 proximal to the second end of the clamping jaw. Clamping jaw 320 includes a series of grooves 345 proximal the second end of the clamping jaw and configured to receive the clasp 340. By securing the clasp 340 into one of the grooves 345, the clamping jaws 310, 320 of the clamping hanger 300 may be secured shut.

In one embodiment, the support frame 100, brackets 200 and clamping hangers 300 may be comprised of aluminum, e.g. aluminum tubing and plate. In other embodiments, the support frame 100, brackets 200 and clamping hangers 300 may be comprised of steel, other metal, wood, plastic, and/or composite material, among others.

Each clamping jaw 310, 320 may include a compressible member 350 running along the length of the inside surface of the respective clamping jaw. As shown in FIG. 4, the stalks of plant material 500 may be arranged in the open clamping jaws 310, 320. Then clamping jaws, 310, 320 may then be squeezed together. The compressible members 350 may function to compress around the stalks of the plant material 500 and hold it securely in place so long as the jaws 320, 310 are secured shut by the clasp 340.

The compressing action of the compressible members 350 around the stems of plant material 500 may prevent damage to the stocks of plant material 500 and/or provide enhanced grip on the stocks.

In some embodiments, the compressible members 350 may be comprised of a natural rubber and/or rubber-like polymer. The rubber or rubber-like material may provide compression and increased friction over other materials. In other embodiments, the compressible members 350 may be comprised of fabric, foam, and/or composite materials, among others.

Furthermore, returning to FIG. 2, the notches 210 may be configured to secure the outer edges of the clamping jaws of clamping hanger 300. In this manner the notches 210 may provide a backup to the clasp 340, preventing the jaws from opening so long as the clamping hanger 300 is secured in the notch 210.

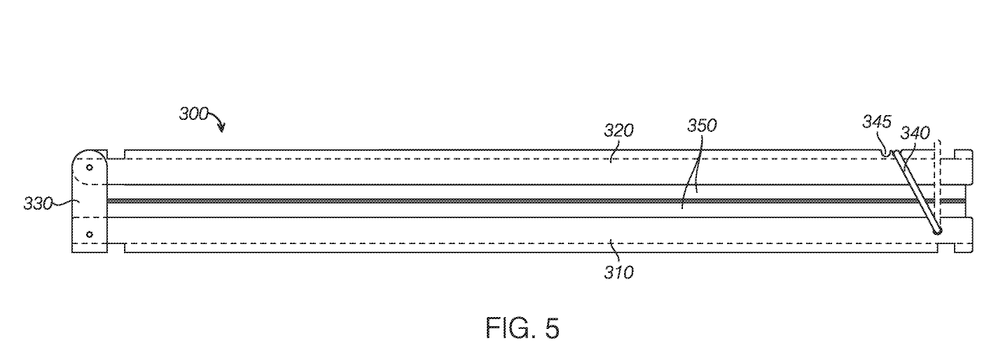

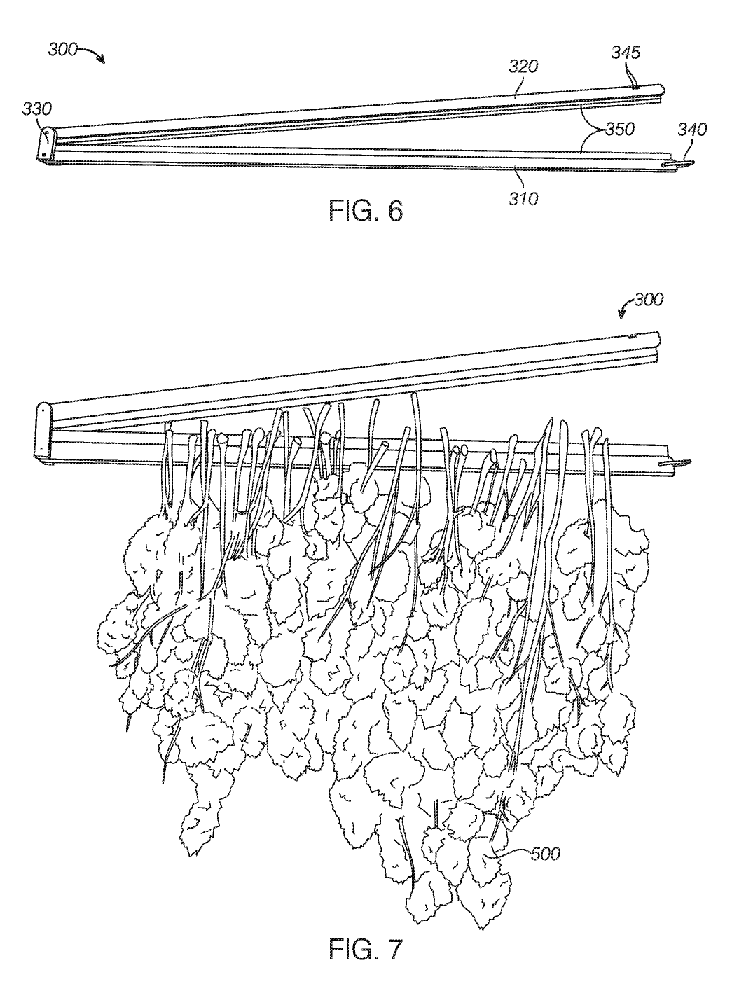

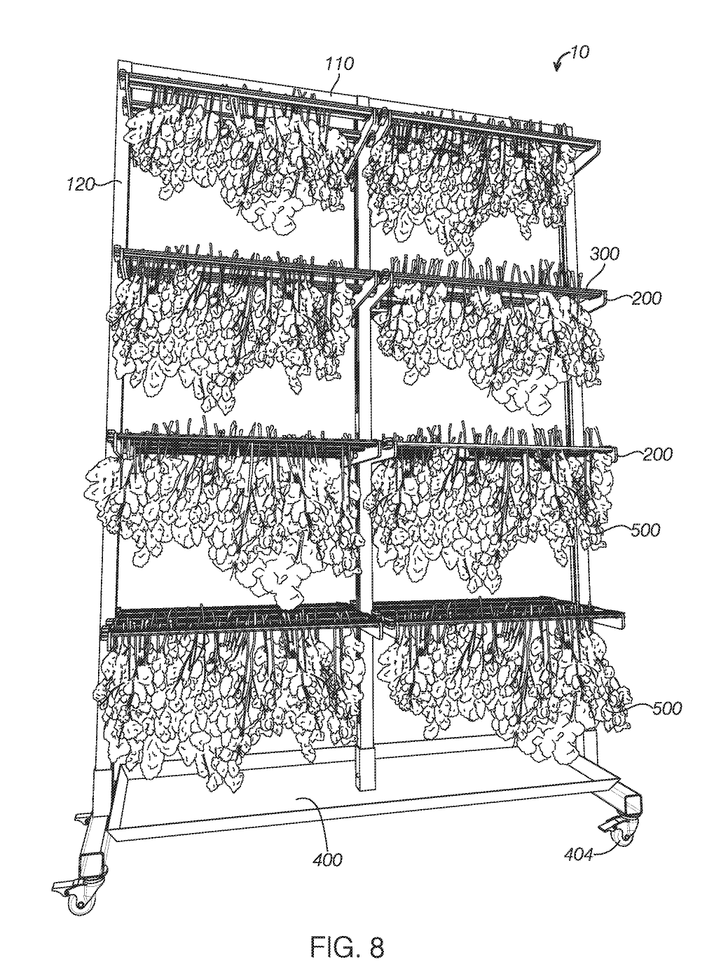

As can be seen in FIG. 5, plant material 500 may be loaded into each clamping hanger 300 in order to very efficiently fill the device 10 with drying plant material 500. The plant material 500 is held in place by the clamping hangers 300. Due to the configuration of device 10, the plant material 500 may be exposed on all sides to ambient air to even dry the plant material 500.

Furthermore, as shown in FIG. 5, device 10 may include removable catch tray 400 and wheels 404. The removable catch tray 400 may function to catch any debris that falls from the drying plant material 500. The wheels 404 may function to allow the device 10 to be moved around the drying space while fully assembled and loaded with drying plant material 500.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A drying rack system for drying plant material, the system comprising:
a frame comprising horizontal members and vertical members;
an array of brackets supported by the frame; and
a plurality of clamping hangers supported by the brackets;
wherein a first clamping hanger of the plurality of clamping hangers comprises:
a pair of opposing clamping jaws configured to compress against each other; and
a hinge securing the clamping jaws together proximal one end of the first clamping jaw.

2. The system of claim 1, wherein the first clamping hanger comprises a clasp configured to selectively hold the clamping jaws shut.

3. The system of claim 2, wherein the first clamping hanger includes a series of grooves, the series of grooves configured to receive the clasp and selectively adjust the compression of the clamping jaws.

4. The system of claim 1, wherein the first clamping hanger comprises a first compressible member disposed on a first clamping jaw of the pair of opposing clamping jaws.

5. The system of claim 4, wherein the first clamping hanger comprises a second compressible member disposed on a second clamping jaw of the pair of opposing clamping jaws, the first and second compressible members configured to compress against each other when the clamping jaws are shut.

6. The system of claim 4, wherein the first compressible member comprises a rubber material.

7. The system of claim 1, wherein the frame comprises removable fasteners fastening the vertical members to the horizontal members.

8. The system of claim 1 comprising a removable catch tray disposed proximal the bottom of the frame.

9. The system of claim 1, wherein the vertical members include vertical slots, each bracket being secured to the vertical members via the vertical slots.

10. The system of claim 1, wherein the first clamping hanger is supported on each end via a pair of opposing brackets of the array of brackets.

11. The system of claim 10, wherein each of the pair of brackets comprises opposing notches, the notches being configured to receive the ends of the first clamping hanger and hold the clamping jaws shut.

12. A drying rack system for drying plant material, the system comprising:
a frame comprising horizontal members and vertical members;
an array of brackets supported by the frame; and
a plurality of clamping hangers supported by the brackets;
wherein a first clamping hanger of the plurality of clamping hangers comprises:
a pair of opposing clamping jaws configured to compress against each other;
a hinge securing the clamping jaws together proximal one end of the first clamping jaw; and
a first compressible member disposed on a first clamping jaw of the pair of opposing clamping jaws.

13. The system of claim 12, wherein the first clamping hanger comprises a clasp configured to selectively hold the clamping jaws shut.

14. The system of claim 13, wherein the first clamping hanger includes a series of grooves, the series of grooves configured to receive the clasp and selectively adjust the compression of the clamping jaws.

15. The system of claim 12, wherein the first clamping hanger comprises a second compressible member disposed on a second clamping jaw of the pair of opposing clamping jaws, the first and second compressible members configured to compress against each other when the clamping jaws are shut.

16. The system of claim 12, wherein the frame comprises removable fasteners fastening the vertical members to the horizontal members.

17. The system of claim 1 comprising a removable catch tray disposed proximal the bottom of the frame.

18. The system of claim 12, wherein the vertical members include vertical slots, each bracket being secured to the vertical members via the vertical slots.

19. The system of claim 12, wherein the first clamping hanger is supported on each end via a pair of opposing brackets of the array of brackets.

20. The system of claim 19, wherein each of the pair of brackets comprises opposing notches, the notches being configured to receive the ends of the first clamping hanger and hold the clamping jaws shut.
